(19) United States
(12) Patent Application Publication
(10) Pub. No.: US 2026/0339907 A1
(43) Pub. Date: Oct. 29, 2026

(54) SYSTEMS AND METHODS FOR AI-DRIVEN DYNAMIC DATA NORMALIZATION FOR HETEROGENEOUS DATA SOURCES

(71) Applicant: Bryan Michael Perdue, Brentwood, TN (US)

(72) Inventor: Bryan Michael Perdue, Brentwood, TN (US)

(21) Appl. No.: 19/659,094

(22) Filed: Apr. 27, 2026

Related U.S. Application Data
(60) Provisional application No. 63/794,870, filed on Apr. 25, 2025.

(51) Int. Cl. G06F 16/215

(52) U.S. Cl. CPC G06F 16/215

(57) ABSTRACT

An AI-driven system and method normalize data across heterogeneous sources. An artificial intelligence model generates proposed linkages between source data values and standardized list elements, each with an associated significance measure. Users select target fields for normalization from multiple data sources, create or choose standardized lists, and evaluation AI-proposed linkages by confirming, rejecting, correcting, or providing feedback that refines future proposals. The system learns from feedback across one or more entities, stores linkage instructions for consistent reuse, generates unified reports from normalized data, and can synchronize corrections back to source systems, ensuring enterprise-wide consistency.

### REFERENCE TO RELATED APPLICATIONS

This application claims the benefit of U.S. Provisional Patent Application 63/794,870, filed on Apr. 25, 2025, incorporated herein by reference.

### BACKGROUND OF THE INVENTION

### Technical Field

This invention relates to data management, data integration, and data processing systems, and more particularly to systems and methods for dynamically normalizing, linkage, and standardizing data across multiple heterogeneous data sources. The invention applies to enterprise applications including accounting systems, client relationship management (CRM) platforms, clinical maintenance management systems (CMMS), resource management, and transaction capture systems.

### Description of the Related Art

Organizations frequently encounter data inconsistencies when managing information across disparate systems. These inconsistencies arise from variations in how data is entered, stored, and formatted across different platforms and departments. Traditional data integration solutions, such as Extract-Transform-Load (ETL) pipelines or predefined linkage schemas, typically offer limited adaptability and require significant technical expertise to implement and maintain. For example, U.S. Pat. No. 9,858,624 describes a system for standardizing financial data using a fixed chart of accounts. However, this solution is limited to a single domain and does not support user-driven normalization across arbitrary fields or synchronization with source systems. Similarly, other existing technologies fail to provide comprehensive solutions that can be easily configured by business users without extensive technical expertise, particularly solutions that allow the user to select any field from any connected system for normalization. These limitations result in persistent data silos, requiring substantial manual reconciliation efforts and often leading to unreliable analytics and reporting. Notably, prior-art normalization systems such as that described in U.S. Pat. No. 9,858,624 rely on a human linkage operator—a “second user” who manually aligns source data fields with a standard chart of accounts through a visual interface. This human-in-the-loop linkage process is labor-intensive, error-prone, and does not scale across large numbers of heterogeneous sources or arbitrary data fields. The present invention eliminates this manual linkage dependency by employing artificial intelligence and machine learning techniques to autonomously determine associations between source data values and standardized list elements, reducing human involvement to exception evaluation of low-confidence linkages. There exists a significant need for a dynamic, configurable system that transcends domain-specific constraints, enables efficient normalization across multiple heterogeneous data sources guided by user selection of the specific field to normalize, leverages AI-driven inference to autonomously map data values without manual user intervention, and offers the flexibility to push standardized data back to source systems.

### SUMMARY OF THE INVENTION

Embodiments of the invention may include one or more of the following features. These features may be used singly, or in combination with each other. The present invention provides an AI-driven system and method for autonomously normalizing data across heterogeneous sources without requiring manual field-to-field linkage by a human operator. At its core, the invention employs an artificial intelligence inference engine that generates vector encodings for both source data values and standardized list elements, computes similarity scores (such as cosine similarity or learned distance metrics), and proposes linkages that exceed a configurable confidence threshold. Human involvement is limited to evaluationing low-confidence proposals and providing natural-textual feedback that retrains the AI model—the user never directly maps fields. This AI-first approach represents a fundamental departure from prior-art normalization systems that require a human linkage operator. The system enables organizations to standardize any chosen data field from disparate systems—such as chart-of-accounts elements across franchise accounting platforms, entity identifiers across CRM systems, product and service codes across transaction capture terminals, transaction-event records across bank feeds, medical device specifications across clinical maintenance management systems, or location identifiers across multi-entity organizations—achieving data uniformity that enables cross-entity comparing, consolidated reporting, and enterprise-wide analytics. When data from dozens or hundreds of entities is normalized to a common standard, organizations gain the ability to compare performance across locations, roll up financial statements, and identify trends that would be invisible in fragmented, inconsistent data. Key features of the invention include: User-Selectable Fields: Allows users, via a user interface, to browse connected sources and select any data field from any source system for normalization, freeing the process from predefined schemas or limitations and enabling generic normalization across diverse data elements and systems. Standardized Lists: Supports the creation or selection of standardized lists (potentially with multi-level hierarchies and version control) to serve as the canonical representation for the user-selected target field. Versatile Linkage: Offers manual, algorithmic (e.g., fuzzy matching, pattern recognition), and AI-driven linkage options to associate source data values (from the selected field) with the standardized list elements. Persistent Linkage Instructions: Stores the generated linkage rules and associations for consistent reuse and automation of the normalization process for the selected field. Consolidated Outputs: Generates unified reports, cross-entity comparing, and enterprise-wide analytics based on the consistently normalized data derived from the user-selected field across all relevant sources. By conforming disparate data to a common standard, the system enables direct comparison of performance metrics, financial statements, and operational data across entities that previously used incompatible data encodings. Source Synchronization: Includes an optional capability to push standardized data values or corrected structures back to the original source systems, enhancing data integrity enterprise-wide based on the completed normalization. Security Features: Incorporates role-based access control and multi-tenant support for secure operation in enterprise environments. This solution reduces manual effort, enhances data consistency for the chosen data element across disparate systems, and enables real-time, enterprise-wide analytics. Its unique ability to push standardized data back to source systems, combined with its adaptability to normalize any user-selected field from any source, sets it apart from existing solutions, enhancing data integrity throughout the enterprise.

The above advantages and features are of representative embodiments only, and are presented only to assist in understanding the invention. It should be understood that they are not to be considered limitations on the invention as defined by the claims. Additional features and advantages of embodiments of the invention will become apparent in the following description, from the drawings, and from the claims.

Aspects described below include a non-transitory computer-readable storage medium comprising computer-executable instructions that, responsive to execution by a processor, cause a system to perform any one of the described methods.

Aspects described below also include a system and method for AI-Driven Dynamic Data Normalization for Heterogeneous Data Sources.

### BRIEF DESCRIPTION OF THE FIGURES

The appended figures depict certain features of the various aspects described herein and are not to be considered limiting of the scope of this disclosure.

FIG. 1 depicts a block diagram of a data processing environment in which illustrative embodiments may be implemented.

FIG. 2 depicts a block diagram of a data processing system in which illustrative embodiments may be implemented.

FIG. 3 is a system architecture block diagram illustrating the high-level components of the data normalization system and their interconnections with heterogeneous data sources.

FIG. 4 is a block diagram illustrating the user interface for browsing connected data sources and selecting a specific target data field for normalization.

FIG. 5 is a flowchart illustrating the process for creating or selecting standardized lists, including hierarchical structures and predefined library access.

FIG. 6 is a conceptual block diagram illustrating the linkage interface components supporting manual, algorithmic, and AI-driven linkage techniques.

FIG. 7 is a flowchart illustrating the comprehensive end-to-end data normalization process from source connection through consolidated output generation.

FIG. 8 is a schematic diagram illustrating how data from disparate sources is processed through standardization and linkage to produce a unified consolidated report.

FIG. 9 is a flowchart detailing the AI-based linkage workflow, including vector embedding generation, similarity scoring against a confidence threshold, user evaluation, and AI model retraining from feedback.

FIG. 10 is a flowchart illustrating the Source System Update Process for transmitting normalized data corrections back to source systems with error handling and retry logic.

FIG. 11 is a block diagram illustrating the structure of the Predefined Standard List Library organized by industry and general categories with management tools.

FIG. 12 is a flowchart illustrating the cross-entity learning process whereby confirmed linkage instructions from one entity are stored as learned standards, automatically applied to subsequent entities, and progressively accumulated to increase linkage accuracy across all connected entities.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known structures, functions, methods, procedures, components, and/or circuitry have been described at a relatively high level, without detail, to avoid unnecessarily obscuring aspects of the present teachings.

Unless the context clearly requires otherwise, throughout the description and the claims, the words “comprise,” “comprising,” and the like are to be construed in an inclusive sense as opposed to an exclusive or exhaustive sense; that is to say, in the sense of “including, but not limited to.” Words using the singular or plural number also include the plural or singular number respectively. Additionally, the words “herein,” “above,” “below” and words of similar import, when used in this application, shall refer to this application as a whole and not to any particular portions of this application. When the claims use the word “or” in reference to a list of two or more items, that word covers all of the following interpretations of the word: any of the items in the list, all of the items in the list and any combination of the items in the list. When the word “each” is used to refer to an element that was previously introduced as being at least one in number, the word “each” does not necessarily imply a plurality of the elements, but can also mean a singular element.

The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

The illustrative embodiments are described with respect to certain types of machines. The illustrative embodiments are also described with respect to other scenes, subjects, measurements, devices, data processing systems, environments, components, and applications only as examples. Any specific manifestations of these and other similar artifacts are not intended to be limiting to the disclosure. Any suitable manifestation of these and other similar artifacts can be selected within the scope of the illustrative embodiments.

Furthermore, the illustrative embodiments may be implemented with respect to any type of data, data source, or access to a data source over a data network. Any type of data storage device may provide the data to an embodiment of the disclosure, either locally at a data processing system or over a data network, within the scope of the disclosure. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific surveys, code, hardware, algorithms, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable devices, structures, systems, applications, or architectures therefor, may be used in conjunction with such embodiment of the disclosure within the scope of the disclosure. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various processes described herein may be implemented by appropriately programmed general purpose computers, special purpose computers, and computing devices. Typically, a processor (e.g., one or more microprocessors, one or more microcontrollers, one or more digital signal processors) will receive instructions (e.g., from a memory or like device), and execute those instructions, thereby performing one or more processes defined by those instructions. Instructions may be embodied in one or more computer programs, one or more scripts, or in other forms. The processing may be performed on one or more microprocessors, central processing units (CPUs), computing devices, microcontrollers, digital signal processors, or like devices or any combination thereof. Programs that implement the processing, and the data operated on, may be stored and transmitted using a variety of media. In some cases, hard-wired circuitry or custom hardware may be used in place of, or in combination with, some or all of the software instructions that can implement the processes. Algorithms other than those described may be used.

Programs and data may be stored in various media appropriate to the purpose, or a combination of heterogeneous media that may be read and/or written by a computer, a processor or a like device. The media may include non-volatile media, volatile media, optical or magnetic media, dynamic random access memory (DRAM), static ram, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge or other memory technologies. Transmission media include coaxial cables, copper wire and fiber optics, including the wires that comprise a system bus coupled to the processor.

Databases may be implemented using database management systems or ad hoc memory organization schemes. Alternative database structures to those described may be readily employed. Databases may be stored locally or remotely from a device which accesses data in such a database.

In some cases, the processing may be performed in a network environment including a computer that is in communication (e.g., via a communications network) with one or more devices. The computer may communicate with the devices directly or indirectly, via any wired or wireless medium (e.g. the Internet, LAN, WAN or Ethernet, Token Ring, a telephone line, a cable line, a radio channel, an optical communications line, commercial on-line service providers, bulletin board systems, a satellite communications link, a combination of any of the above). Each of the devices may themselves comprise computers or other computing devices, such as those based on an Intel® or AMD® processor, that are adapted to communicate with the computer. Any number and type of devices may be in communication with the computer.

A server computer or centralized authority may or may not be necessary or desirable. In various cases, the network may or may not include a central authority device. Various processing functions may be performed on a central authority server, one of several distributed servers, or other distributed devices.

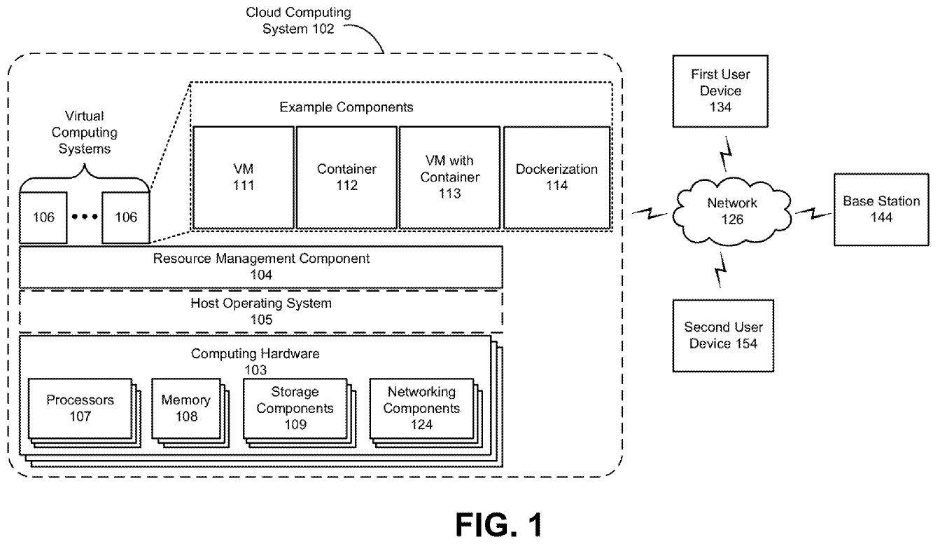

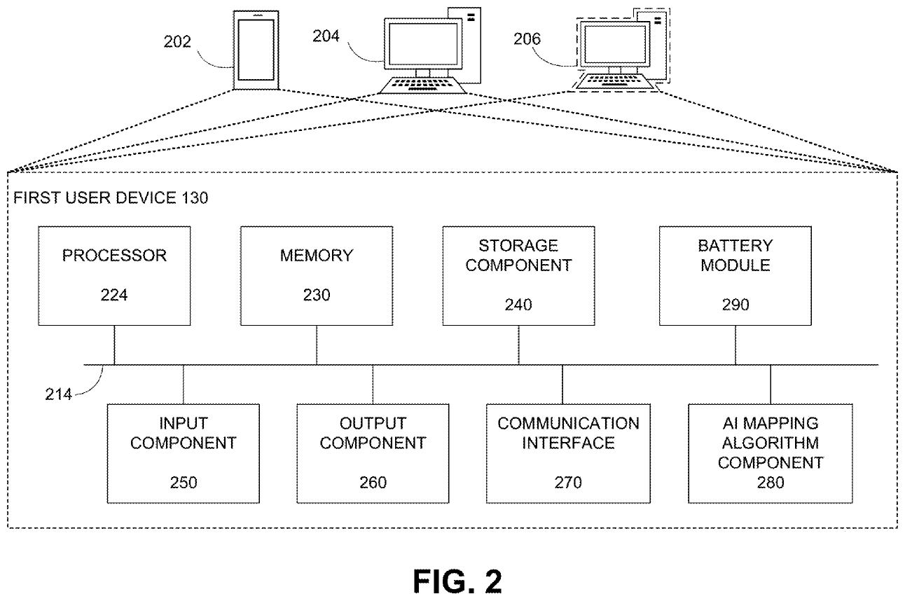

With reference to the figures and in particular, with reference to FIG. 1 and FIG. 2, these figures are example diagrams of data processing environments in which illustrative embodiments may be implemented. FIG. 1 and FIG. 2 are only examples and are not intended to assert or imply any limitation with regard to the environments in which different embodiments may be implemented. A particular implementation may make many modifications to the depicted environments based on the following description.

FIG. 1 is a diagram of an example environment in which systems and/or methods described herein may be implemented. As shown in FIG. 1, the environment may execute within a cloud computing system 102. The cloud computing system 102 may include one or more elements 103-113, as described in more detail below. As further shown in FIG. 1, the environment may include a network 126, a first user device 134, and/or a base station 144. Devices and/or elements of the environment may interconnect via wired connections and/or wireless connections. It is important to note that first user device 134, as described herein, is a user device which may be used by the first user and/or the second user. In the later case, when it is used by the second user, user device 134 may also be called a second user device 134. For purposes of convenience in reading this description, the embodiment of the user device 134 as a first user device will be described, but it should be understood as interchangeably termed “second user device” at least for the purposes of the disclosures of FIG. 1 and FIG. 2.

The cloud computing system 102 includes computing hardware 103, a resource management component 104, a host operating system (OS) 105, and/or one or more virtual computing systems 106. The resource management component 104 may perform virtualization (e.g., abstraction) of the computing hardware 103 to create the one or more virtual computing systems 106. Using virtualization, the resource management component 104 enables a single computing device (e.g., a computer, a server, and/or the like) to operate like multiple computing devices, such as by creating multiple isolated virtual computing systems 106 from the computing hardware 103 of the single computing device. In this way, the computing hardware 103 can operate more efficiently, with lower power consumption, higher reliability, higher availability, higher utilization, greater flexibility, and lower cost than using separate computing devices.

The computing hardware 103 includes hardware and corresponding resources from one or more computing devices. For example, the computing hardware 103 may include hardware from a single computing device (e.g., a single server) or from multiple computing devices (e.g., multiple servers), such as multiple computing devices in one or more data centers. As shown, the computing hardware 103 may include one or more processors 107, one or more memories 108, one or more storage components 109, and/or one or more networking components 124. Examples of a processor, a memory, a storage component, and a networking component (e.g., a communication component) are described elsewhere herein.

The resource management component 104 includes a virtualization application (e.g., executing on hardware, such as the computing hardware 103) capable of virtualizing the computing hardware 103 to start, stop, and/or manage the one or more virtual computing systems 106. For example, the resource management component 104 may include a hypervisor (e.g., a bare-metal or Type 1 hypervisor, a hosted or Type 2 hypervisor, and/or the like) or a virtual machine monitor, such as when the virtual computing systems 106 are virtual machines 111. Additionally, or alternatively, the resource management component 104 may include a container manager, such as when the virtual computing systems 106 are containers 112. In some implementations, the resource management component 104 executes within and/or in coordination with a host operating system 105.

A virtual computing system 106 includes a virtual environment that enables cloud-based execution of operations and/or processes described herein using computing hardware 103. As shown, the virtual computing system 106 may include a virtual machine 111, a container 112, a hybrid environment 113 that includes a virtual machine and a container, an environment which includes Docker-like filesystems or other possible Dockerization 114 with a VM or other computing hardware allocation, and/or the like. A virtual computing system 106 may execute one or more applications using a file system that includes binary files, software libraries, and/or other resources required to execute applications on a guest operating system (e.g., within the virtual computing system 106) or the host operating system 105.

The network 126 includes one or more wired and/or wireless networks. For example, the network 126 may include a cellular network, a public land mobile network (PLMN), a local area network (LAN), a wide area network (WAN), a satellite network, a private network, the Internet, and/or the like, and/or a combination of these or other types of networks. The network 126 enables communication among the devices of the environment.

First user device 134 may be possessed by a first user and includes one or more devices capable of receiving, generating, storing, processing, and/or providing information, as described elsewhere herein. First user device 134 may include a communication device and/or a computing device. For example, first user device 134 may include a wireless communication device, a mobile phone, a user equipment (UE), a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device.

The base station 144 may support, for example, a cellular radio access technology (RAT). The base station may include one or more base stations (e.g., base transceiver stations, radio base stations, node Bs, eNodeBs (eNBs), gNodeBs (gNBs), base station subsystems, cellular sites, cellular towers, access points, transmit receive points (TRPs), radio access nodes, macrocell base stations, microcell base stations, picocell base stations, femtocell base stations, or similar types of devices) and other network entities that can support wireless communication for the base station 144. The first user device 134 may transfer traffic between the base station 144 (e.g., using a cellular RAT), one or more base stations (e.g., using a wireless interface or a backhaul interface, such as a wired backhaul interface), and/or a core network. The first user device 134 may provide one or more cells that cover geographic areas.

The Second user device 154 may be possessed by a second user and includes one or more devices capable of receiving, generating, storing, processing, and/or providing information, as described elsewhere herein. Second user device 154 may include a communication device and/or a computing device, and may be connected to, or embedded anywhere within, a vehicle or other equipment known to be utilized in the transportation industry. For example, Second user device 154 may include a wireless communication device, a mobile phone, a vehicle computer system, a mobile printer, a calculator, a user equipment, a laptop computer, a tablet computer, a desktop computer, a set-top box, a wearable communication device (e.g., a smart wristwatch, a pair of smart eyeglasses, a head mounted display, or a virtual reality headset), or a similar type of device.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g., one or more devices) of the environment may perform one or more functions described as being performed by another set of devices of the environment.

FIG. 2 is a diagram of components of first user device 134, according to an example of the present disclosure. First user device 134 may include a bus 214, a processor 224, a memory 230, a storage component 240, an input component 254, an output component 260, a communication interface 270, and battery module 290.

Bus 214 includes a component that permits communication among the components of First user device 134. Processor 224 is implemented in hardware, firmware, or a combination of hardware and software. Processor 224 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, processor 224 includes one or more processors capable of being programmed to perform a function. Memory 230 may include one or more memories such as a random access memory (RAM), a read only memory (ROM), and/or another type of dynamic or static storage device (e.g., a flash memory, a magnetic memory, and/or an optical memory) that stores information and/or instructions for use by processor 224. In some embodiments, a non-transitory computer-readable medium stores instructions that, when executed by a processor, cause the processor to perform various functions.

Storage component 240 stores information and/or software related to the operation and use of First user device 134. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 254 includes a component that permits first user device 134 to receive information, such as via user input (e.g., a touch screen display, a keyboard, a keypad, a mouse, a button, a switch, and/or a microphone). Additionally, or alternatively, input component 254 may include a sensor for sensing information (e.g., a GPS component, an accelerometer, a gyroscope, and/or an actuator). Output component 260 includes a component that provides output information from first user device 134 (e.g., a display, a speaker, a user interface, and/or one or more light-emitting diodes (LEDs)). Output component 260 may include a display providing a GUI, such as interface 300. Input component 254 and output component 260 may be combined into a single component, such as a touch responsive display, also known as a touchscreen.

Communication interface 270 includes a transceiver-like component (e.g., a transceiver and/or a separate receiver and transmitter) that enables first user device 134 to communicate with other devices, such as via a wired connection, a wireless connection, or a combination of wired and wireless connections. Communication interface 270 may permit first user device 134 to receive information from another device and/or provide information to another device. Communication interface 270 may include one or more RFFEs (radio frequency front ends) with antennae circuitry and RF (radio frequency) filters which may be variable power and/or purpose adapted for various communication frequencies, standards, links, and distances. For example, communication interface 270 may include an Ethernet interface, an optical interface, a coaxial interface, an infrared interface, an RF interface, a universal serial bus (USB) interface, a Wi-Fi interface, a cellular network interface, or the like.

Battery module 290 is connected along bus 214 to supply power to processor 224, memory 230, and internal components of first user device 134. Battery module 290 may supply power during field measurements by first user device 134. Battery module 290 permits First user device 134 to be a portable integrated device for conducting field measurements of propagation delay in a RAN.

First user device 134 may perform one or more processes described herein. First user device 134 may perform these processes by processor 224 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may instruct processor 224 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, first user device 134 may include additional components, fewer components, different components, or differently arranged components than those shown in FIG. 2, 200. Additionally, or alternatively, a set of components (e.g., one or more components) of first user device 134 may perform one or more functions described as being performed by another set of components of first user device 134.

FIG. 2 is a diagram of components of first user device 134, according to an example of the present disclosure. First user device 134 may include a bus 214, a processor 224, a memory 230, a storage component 240, an input component 254, an output component 260, a communication interface 270, battery module 290 and AI mapping algorithm component 280.

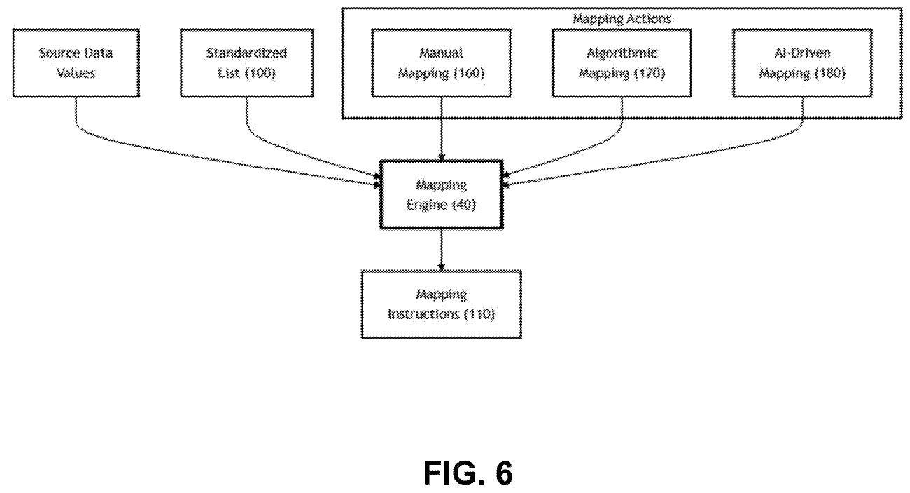

Bus 214 includes a component that permits communication among the components of First user device 134. Processor 224 is implemented in hardware, firmware, or a combination of hardware and software. Processor 224 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some examples, processor 224 includes one or more processors capable of being programmed to perform a function. According to an example, processor 224 is processor 224 of FIG. 6. Memory 230 may include one or more memories such as a random-access memory (RAM), a read only memory (ROM), and/or another type of dynamic or static storage device (e.g., a flash memory, a magnetic memory, and/or an optical memory) that stores information and/or instructions for use by processor 224.

Storage component 240 stores information and/or software related to the operation and use of First user device 134. For example, storage component 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

Input component 254 includes a component that permits first user device 134 to receive information, such as via user input (e.g., a touch screen display, a keyboard, a keypad, a mouse, a button, a switch, and/or a microphone). Additionally, or alternatively, input component 254 may include a sensor for sensing information (e.g., a GPS component, an accelerometer, a gyroscope, and/or an actuator). Output component 260 includes a component that provides output information from first user device 134 (e.g., a display, a speaker, a user interface, and/or one or more light-emitting diodes (LEDs)). Output component 260 may include a display providing a GUI, such as interface 300. Input component 254 and output component 260 may be combined into a single component, such as a touch responsive display, also known as a touchscreen.

Communication interface 270 includes a transceiver-like component (e.g., a transceiver and/or a separate receiver and transmitter) that enables first user device 134 to communicate with other devices, such as via a wired connection, a wireless connection, or a combination of wired and wireless connections. Communication interface 270 may include one or more short range communication interface modules and medium/long range communication interface modules, and may permit first user device 134 to receive information from another device and/or provide information to another device. For example, communication interface 270 may include an Ethernet interface, an optical interface, a coaxial interface, an infrared interface, an RF interface, a universal serial bus (USB) interface, a Wi-Fi interface, a cellular network interface, or the like.

Battery module 290 is connected along bus 214 to supply power to processor 224, memory 230, and internal components of first user device 134. Battery module 290 permits First user device 134 to be a portable integrated device for conducting field measurements of propagation delay in a RAN.

First user device 134 may perform one or more processes described herein. First user device 134 may perform these processes by processor 224 executing software instructions stored by a non-transitory computer-readable medium, such as memory 230 and/or storage component 240. A computer-readable medium is defined herein as a non-transitory memory device. A memory device includes memory space within a single physical storage device or memory space spread across multiple physical storage devices.

Software instructions may be read into memory 230 and/or storage component 240 from another computer-readable medium or from another device via communication interface 270. When executed, software instructions stored in memory 230 and/or storage component 240 may instruct processor 224 to perform one or more processes described herein. Additionally, or alternatively, hardwired circuitry may be used in place of or in combination with software instructions to perform one or more processes described herein. Example embodiments Second user device 154 may include a mobile device/user equipment (UE) 202, a personal computer 204, or a virtual computing system 206 which may include various implementations such as those of 106. Thus, implementations described herein are not limited to any specific combination of hardware circuitry and software.

The number and arrangement of components shown in FIG. 2 are provided as an example. In practice, first user device 134 may include additional components, fewer components, different components, or differently arranged components than those shown in FIG. 2. Additionally, or alternatively, a set of components (e.g., one or more components) of first user device 134 may perform one or more functions described as being performed by another set of components of first user device 134.

### Systems and Methods for AI-Driven Dynamic Data Normalization for Heterogeneous Data Sources

Illustrative embodiments of the invention are described below. The following explanation provides specific details for a thorough understanding of and enabling description of these embodiments. One skilled in the art will understand that the invention may be practiced without such details. In other instances, well-known structures and functions have not been shown or described in detail to avoid unnecessarily obscuring the description of the embodiments. A fundamental aspect of the described embodiments is the capability for a user to dynamically and generically select any data field present within any connected heterogeneous data source as the target for normalization, thereby providing a universally adaptable data standardization solution.

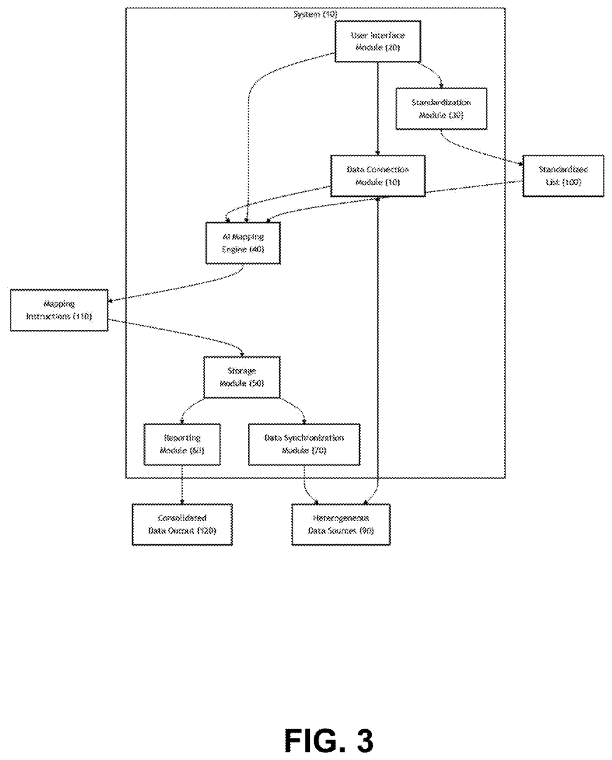

Referring first to FIG. 3, the system architecture block diagram provides a high-level overview of the invention's components and their interconnections. The system 10 is designed to interact with a plurality of Heterogeneous Data Sources 90. These sources represent diverse external systems common in enterprise environments, such as different accounting packages (e.g., QuickBooks, NetSuite), CRM platforms (e.g., Salesforce, Dynamics 365), clinical maintenance management systems (CMMS), resource management systems, transaction capture terminals, databases, or even structured files. Preferably, the transaction capture terminals are point-of-capture systems. A key challenge addressed by the invention is that these sources 90 often contain conceptually similar data (like entity identifiers, product identifiers, chart of accounts elements) but store and represent this data using inconsistent field names, formats, and values. Preferably, the chart of accounts elements are chart-of-accounts elements. The architecture shows the Data Connection Module 10 as the gateway to these sources, retrieving data and metadata. The User Interface Module 20 facilitates user interaction. The Standardization Module 30 and Linkage Engine 40 perform the core normalization logic, supported by the Storage Module 50 for persistence. The Reporting Module 60 consumes normalized data, and the Data Synchronization Module 70 enables pushing data back. This modular design supports the system's ability to connect to and process data from virtually any source system.

The Data Connection Module 10 is the system's interface to these diverse Heterogeneous Data Sources 90. It is responsible for establishing, managing, and maintaining secure electronic connections. This module employs various mechanisms tailored to the specific source systems, including Application Programming Interfaces (APIs), database connectors (e.g., ODBC, JDBC), file parsing utilities (for CSV, XML, JSON, etc.), or other suitable data extraction protocols. Its function is to retrieve the necessary data, specifically the values from the user-selected target data field across the relevant sources, and make it available to the internal processing modules of the system 10. The Data Connection Module 10 is depicted as directly interfacing with the Heterogeneous Data Sources 90, acting as the initial point of data ingestion into the normalization workflow.

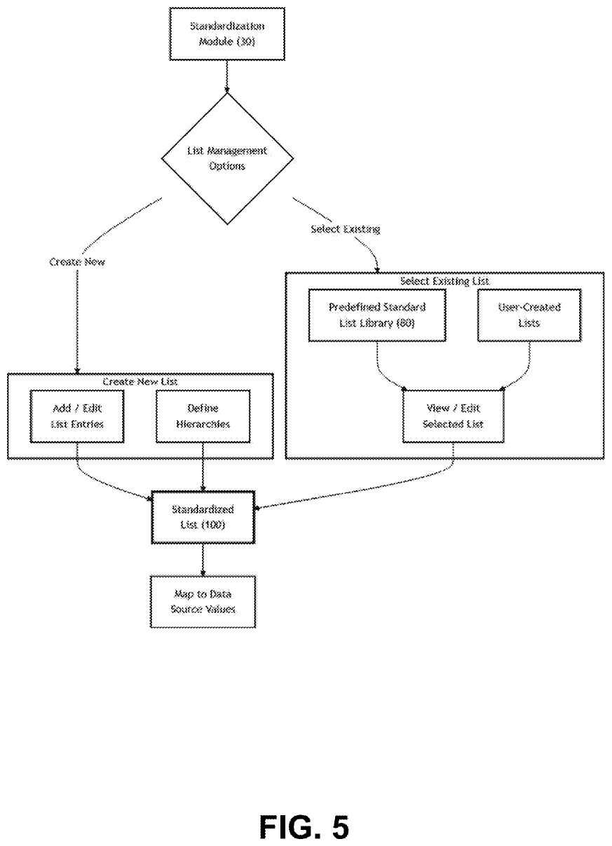

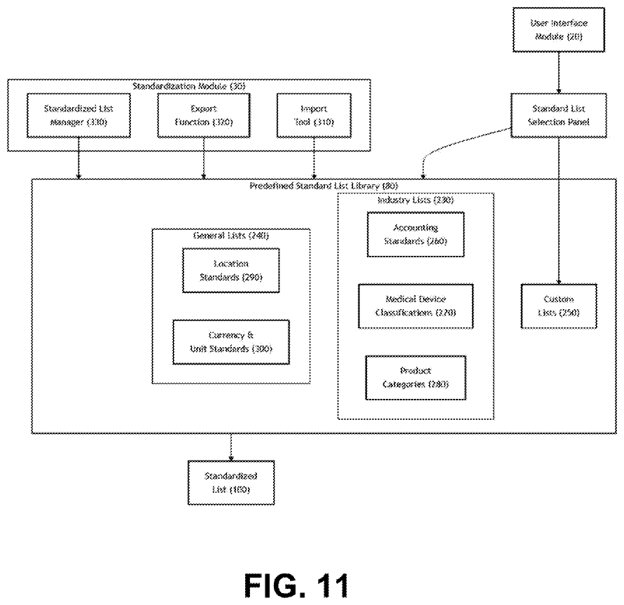

The Standardization Module 30 is central to defining the ‘standard’ in the normalization process. It manages the lifecycle of standardized lists, represented conceptually as Standardized List 100. This involves allowing the user (via the User Interface Module 20) to create new lists from scratch, import lists, or select appropriate lists, potentially from a predefined library (shown in FIG. 11). These lists contain the definitive, canonical values or structures (potentially hierarchical, as discussed in FIG. 5) to which the disparate source data values (from the user-selected field) will be conformed. The Standardization Module 30 interacts with the Storage Module 50 to persist these list definitions and configurations. FIG. 3 shows the Standardization Module 30 interacting with the User Interface Module 20, Linkage Engine 40, and Storage Module 50, indicating its role in providing the standard reference for linkage and storing list definitions.

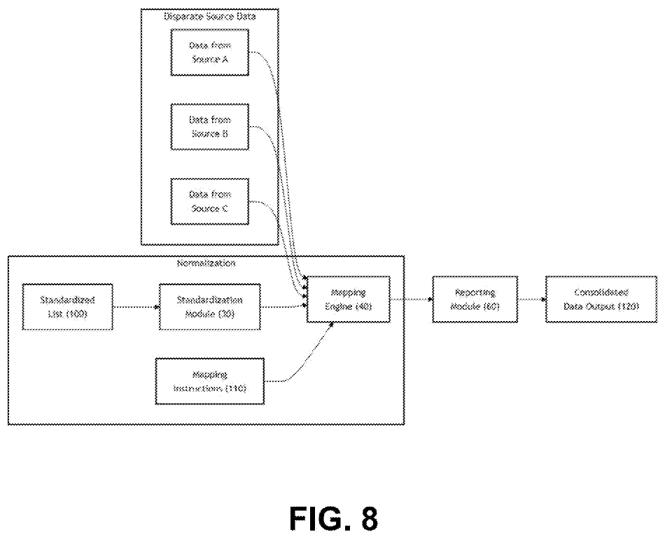

The Linkage Engine 40 is the core processing unit responsible for establishing the relationships between the raw data values retrieved from the Heterogeneous Data Sources 90 (specifically, for the user-selected Target Data Field 150) and the corresponding elements within the chosen Standardized List 100. As detailed in FIG. 6 and FIG. 8, this engine employs a variety of techniques, ranging from direct user-driven manual linkage via the User Interface Module 20, to automated algorithmic approaches (like string similarity or pattern matching), to sophisticated AI-driven predictions. The output of the Linkage Engine 40 is a set of Linkage Instructions 110, which precisely define how each source value should be translated or associated with a standard value. These instructions are crucial for achieving consistent normalization. FIG. 3 illustrates the Linkage Engine 40 receiving data from sources (via Data Connection Module 10), interacting with the Standardization Module 30 for the standard list, receiving input from the User Interface Module 20, and storing results in the Storage Module 50.

The Storage Module 50 acts as the system's persistent memory. It securely stores essential configuration data and operational artifacts, including the connection details for Heterogeneous Data Sources 90, the definitions of all Standardized Lists 100 managed by the Standardization Module 30, the crucial Linkage Instructions 110 generated by the Linkage Engine 40, user preferences, access control information, system logs, and potentially version history for lists and linkages. It provides reliable data retrieval for all other modules requiring access to this stored information. FIG. 3 shows the Storage Module 50 as a central repository accessed by the Standardization Module 30, Linkage Engine 40, Reporting Module 60, and Data Synchronization Module 70.

The Reporting Module 60 leverages the results of the normalization process to provide value to the user. It accesses the normalized data—that is, the original source data transformed according to the stored Linkage Instructions 110 to align with the Standardized List 100—and generates Consolidated Data Output 120. This output can take various forms, such as unified analytical reports, data extracts for business intelligence tools, dashboards visualizing consistent metrics across sources, or files suitable for import into other systems (as illustrated conceptually in FIG. 8). This module allows users to see the benefit of normalization through consistent, aggregated views. FIG. 3 shows the Reporting Module 60 receiving data from the Storage Module 50 (which holds the linkage instructions and normalized data context) and producing the Consolidated Data Output 120.

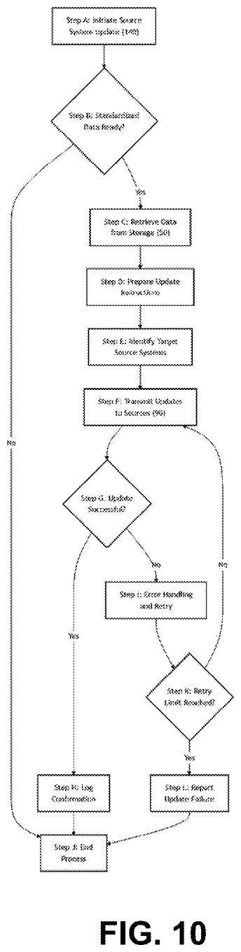

The optional Data Synchronization Module 70 provides an advanced capability to propagate the benefits of normalization back to the source systems. It uses the standardized data values (from the Standardized List 100) and the context provided by the Linkage Instructions 110 (retrieved from the Storage Module 50) to formulate update commands. These commands are then transmitted back to the relevant Heterogeneous Data Sources 90 (via the Data Connection Module 10 or dedicated APIs) to modify the original data, thereby correcting inconsistencies or standardizing values directly at the source. The detailed process is illustrated in FIG. 10. This feedback loop significantly enhances overall enterprise data quality. FIG. 3 shows the Data Synchronization Module 70 interacting with the Storage Module 50 and transmitting data back to the Heterogeneous Data Sources 90.

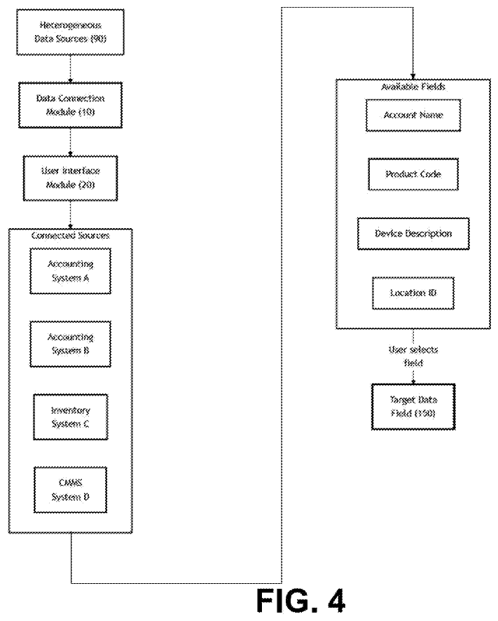

Referring now to FIG. 4, this block diagram focuses on a critical user interaction facilitated by the User Interface Module 20: the selection of the data field to be normalized. The interface presents the user with a representation of the connected Heterogeneous Data Sources 90. This might be a list, a set of icons, or another graphical representation allowing the user to identify and choose a specific source system (e.g., ‘Salesforce CRM Instance 1’, ‘QuickBooks Company File X’, ‘Resource System Prod’). This visual representation of sources is a key element of the interface shown.

Upon the user selecting one of the Heterogeneous Data Sources 90, the User Interface Module 20, interacting with the Data Connection Module 10, queries the selected source to discover the data fields or columns available within it. These available fields are then presented to the user, for example, in a searchable list, a dropdown menu, or a graphical schema view within a dedicated field display area of the interface. Crucially, the system imposes no predefined restrictions on which field can be chosen. The user interaction, indicated by the arrow, allows the user to select any field from this list as the Target Data Field 150. This could be ‘Account Name’ from a CRM, ‘Account Name’ from an accounting system, ‘Product Code’ from resource, ‘Device Description’ from a CMMS, or any other data element present in the source that the user deems necessary to normalize across one or more systems. This selection of a specific Target Data Field 150 by the user is the pivotal first step that tailors the generic normalization engine to a concrete task, initiating the process of creating or selecting a suitable standardized list and linkage values for that specific field. This flexibility to target any field from any source is a cornerstone of the invention's generic applicability, enabling normalization across diverse systems and data types.

Referring now to FIG. 5, this flowchart illustrates the process flow and user interactions, facilitated by the User Interface Module 20, for managing standardized lists via the Standardization Module 30. This process typically follows the selection of the Target Data Field 150 (as shown in FIG. 4). The Standardization Module 30 is responsible for creating, selecting, and maintaining the canonical Standardized List 100 for the chosen Target Data Field 150. The flowchart details the options available to the user.

The user is presented with List Management Options within the User Interface Module 20. One primary option is to Create New List. Selecting this initiates a New List Creation Interface. Here, the user can manually Add/Edit List Elements, defining the specific standard values that will constitute the Standardized List 100. A significant capability illustrated here is the option to Define Hierarchies. This allows the user to establish parent-child relationships between list elements, essential for representing structured data like charts of accounts, organizational structures, or product categorizations, thus enabling multi-level normalization. The flowchart shows distinct paths for adding/editing elements and defining hierarchies within the new list creation process.

Alternatively, the user may choose to Select Existing List. This option provides access either to lists previously created by users or, importantly, to the Predefined Standard List Library 80 (detailed in FIG. 11). If accessing the library, the user can Select List from Library. Whether selecting a user-created list or one from the library, the interface typically allows the user to View/Edit Selected List to ensure it meets the requirements for the current Target Data Field 150 before confirming its use. The flowchart shows branching paths for selecting from the library or existing lists and the option to view/edit. Once the appropriate Standardized List 100 is finalized (either newly created or selected and potentially edited), it becomes the designated target structure for the next step: Map to Data Source values, which is handled by the Linkage Engine 40 (detailed in FIG. 6). This structured approach, managed by the Standardization Module 30 via the user interface, ensures a well-defined standard is in place before linkage begins for the user-selected field.

Referring now to FIG. 6, this conceptual block diagram illustrates the key elements of a linkage interface provided by the User Interface Module 20. This interface allows the user to interact with the Linkage Engine 40 to establish the crucial links between raw source data values and the chosen standardized representation. Preferably, the linkage interface operates without requiring a manual field-to-field linkage interface. This interface becomes active after a Target Data Field 150 has been selected (FIG. 4) and a corresponding Standardized List 100 has been created or selected (FIG. 5). The diagram shows the relationship between Source Data Values, the Standardized List 100, Linkage Actions, and the resulting Linkage Instructions 110.

The interface typically presents two main sets of information visually: the Source Data Values retrieved from the various Heterogeneous Data Sources 90 for the selected Target Data Field 150 (these are the values needing normalization, e.g., ‘IBM’, ‘Intl. Business Machines’, ‘I.B.M.’), and the elements from the target Standardized List 100 (e.g., ‘International Business Machines’). These are often displayed side-by-side or in linked panels within the interface.

The core functionality revolves around Linkage Actions that the user can perform to create associations. FIG. 6 highlights that the interface, interacting with the underlying Linkage Engine 40, supports multiple linkage techniques to offer flexibility and efficiency in linkage the user-selected field's values.

Manual Linkage 160 Provides controls (e.g., drag-and-drop, selection boxes, confirmation buttons) allowing the user to explicitly and directly link a specific Source Data Value to a specific entry in the Standardized List 100. This gives the user precise control for ambiguous or complex cases. The user's manual associations are captured by the Linkage Engine 40. The diagram shows a direct link from Manual Linkage 160 to Linkage Instructions 110 via the Linkage Engine 40.

Algorithmic Linkage 170: Represents user-invoked automated routines within the Linkage Engine 40. The user might trigger an action like “Find Matches” or “Apply Rules.” The Linkage Engine 40 then executes predefined algorithms or similarity criteria, such as exact string matching (case-sensitive or insensitive), fuzzy matching (e.g., Levenshtein distance, Jaro-Winkler) to find similar strings, pattern recognition (e.g., using regular expressions to identify formats like phone numbers or codes), or custom business rules. Preferably, the predefined algorithms or similarity criteria include pattern constraints used to govern identification of matching values.

Preferably, the pattern recognition is performed according to rule-based pattern constraints. These algorithms automatically propose or create linkages based on the defined criteria. The diagram shows Algorithmic Linkage 170 as an input to the Linkage Engine 40, influencing the Linkage Instructions 110. Preferably, the pattern recognition is performed prior to application of the AI model or in combination with the AI model.

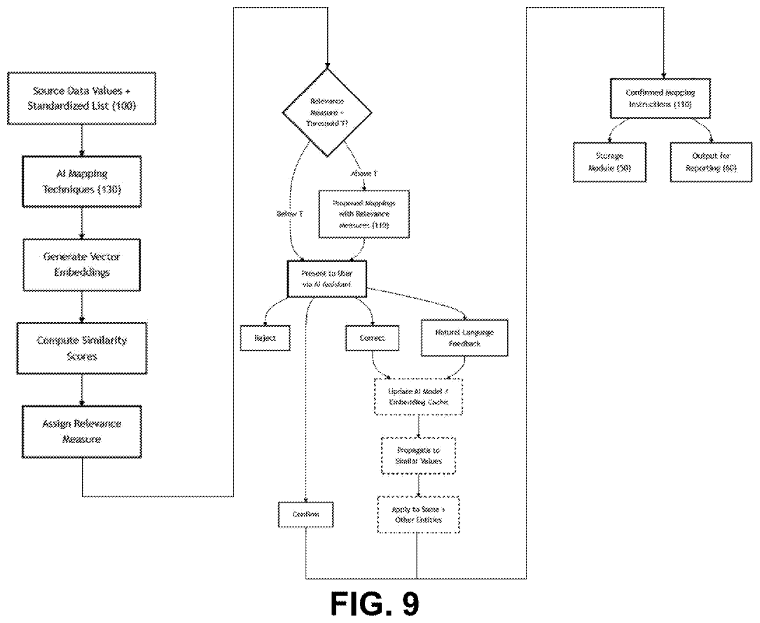

AI-Driven Linkage 180: Allows the user to leverage more advanced artificial intelligence capabilities of the Linkage Engine 40 (detailed further in FIG. 9). The user might trigger an action like “Predict Linkages.” The AI models within the Linkage Engine 40 then analyze the Source Data Values and the Standardized List 100, potentially considering context, semantics, or historical linkage data, to predict the most likely correct associations. This can significantly accelerate linkage for large and complex datasets. The diagram shows AI-Driven Linkage 180 as another input to the Linkage Engine 40, contributing to the Linkage Instructions 110.

Regardless of which technique(s) the user employs via the interface (Manual, Algorithmic, AI-Driven), the interactions serve as input to the Linkage Engine 40. The Linkage Engine 40 processes these inputs, applies the chosen logic (manual association, algorithm, or AI model), references the Standardized List 100, and operates on the Source Data Values. The crucial outcome is the generation and/or update of the Linkage Instructions 110. These instructions are the persistent record of the established value-to-value relationships (e.g., ‘IBM’ maps to ‘International Business Machines’, ‘Intl. Business Machines’ maps to ‘International Business Machines’). These stored Linkage Instructions 110 ensure that the normalization is applied consistently whenever data from the Target Data Field 150 is processed for reporting (FIG. 8) or synchronization (FIG. 10).

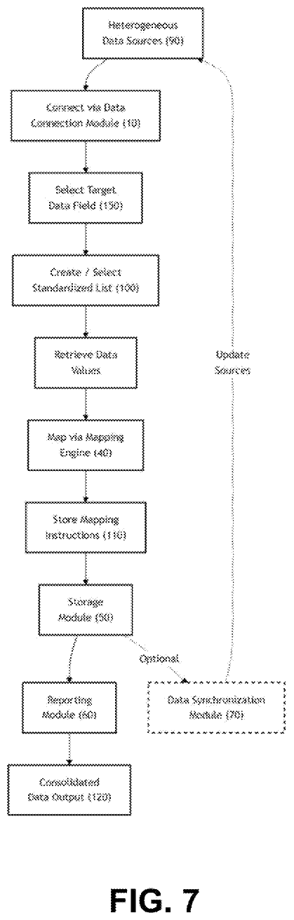

Referring now to FIG. 7, this flowchart provides a comprehensive, end-to-end view of the data normalization process enabled by the invention. The process originates with the existence of multiple Heterogeneous Data Sources 90, representing the initial state of potentially inconsistent data spread across various enterprise systems (e.g., accounting, CRM, financial management, POS, resource). The flowchart maps the sequence of steps from initial connection to final output.

The process formally begins when the Data Connection Module 10 establishes the necessary electronic connections to these Heterogeneous Data Sources 90, using appropriate protocols (APIs, DB connectors, file access) to enable data retrieval. A critical, user-driven step follows: the user interacts with the User Interface Module 20 to select the specific Target Data Field 150 that they wish to normalize. This selection is fundamental—it dictates which data element (e.g., account names, product codes, device specifications, specific account codes) the entire subsequent process will focus on, highlighting the system's ability to generically address any field designated by the user from any connected source system. The flowchart explicitly shows “Select Target Data Field (150)” as a distinct step after connecting to sources.

Once the Target Data Field 150 is identified, the Standardization Module 30 is invoked. Guided by user input via the User Interface Module 20, this module facilitates the creation of a new, tailored Standardized List 100 or the selection of an existing one (perhaps from the library shown in FIG. 11) that defines the canonical representation for the chosen Target Data Field 150. This list may include hierarchical structures if appropriate for the selected field. The flowchart shows “Create/Select Standardized List (100)” following field selection.

With the Standardized List 100 defined and the connections established, the Data Connection Module 10 retrieves the actual data values corresponding to the Target Data Field 150 from the relevant Heterogeneous Data Sources 90. These retrieved values are then passed to the Linkage Engine 40. The Linkage Engine 40 performs the core transformation logic: it maps the retrieved source values to their corresponding elements in the Standardized List 100. As detailed in FIG. 6, this linkage utilizes one or more methods: direct manual associations made by the user via the interface, automated algorithmic matching based on predefined criteria, or AI-driven predictions. The result of this linkage activity is the creation of specific Linkage Instructions 110. The flowchart shows “Retrieve Data Values” followed by “Map Data Values to Standardized List (100)” using the Linkage Engine (40).

These generated Linkage Instructions 110, which encapsulate the logic for transforming each unique source value for the Target Data Field 150 into its standardized form, are then persistently stored by the Storage Module 50. This ensures the linkage logic is saved, auditable, and reusable for subsequent normalization tasks involving the same Target Data Field 150. The flowchart includes the step “Store Linkage Instructions (110)” using the Storage Module (50).

From this point, the process typically proceeds to utilize the normalized data. One path leads to the Reporting Module 60. This module accesses the original data values and applies the stored Linkage Instructions 110 to transform them according to the Standardized List 100. It then generates the Consolidated Data Output 120 (e.g., unified reports, analytical dashboards, data extracts) presenting a consistent view of the data for the originally selected Target Data Field 150 across all sources, enabling reliable analysis (as illustrated in FIG. 8). The flowchart shows a path from Storage Module (50) to Reporting Module (60) generating Consolidated Data Output (120).

An alternative or additional path involves the Data Synchronization Module 70. If this optional feature is utilized, the module retrieves the normalized values (derived from the Standardized List 100) and the Linkage Instructions 110 from the Storage Module 50. It then initiates the process (detailed in FIG. 10) to transmit updates back to the original Heterogeneous Data Sources 90, effectively correcting or standardizing the data for the Target Data Field 150 directly within the source systems. The flowchart shows an optional path from Storage Module (50) to Data Synchronization Module (70) updating Heterogeneous Data Sources (90).

This end-to-end flowchart highlights the complete workflow, emphasizing the user's central role in selecting any target field from any source, the flexible linkage capabilities, and the dual outcomes of consolidated reporting and optional source system updates, all contributing to a powerful and adaptable solution for normalizing diverse data elements across disparate systems.

Referring now to FIG. 8, this schematic diagram provides a conceptual illustration of how the system generates a consolidated output from disparate source data, focusing on the result of the normalization process for the user-selected Target Data Field 150. The inputs are represented as data streams originating from multiple distinct Heterogeneous Data Sources 90, labelled here as Data from Source A (e.g., an accounting system), Data from Source B (e.g., a CRM platform), and Data from Source C (e.g., a clinical maintenance management system). Each stream contains values for the same conceptual data element (the one chosen as the Target Data Field 150), but these values are likely inconsistent across the sources (e.g., Source A might have ‘Acme Corp.’, Source B might have ‘ACME Corporation’, Source C might have ‘Acme Co.’ for an account name field). The diagram visually depicts these separate inputs converging.

These disparate data streams are processed by the core normalization components: the Standardization Module 30 and the Linkage Engine 40. The Standardization Module 30 provides the context of the relevant Standardized List 100 (e.g., containing the entry ‘Acme Corporation’). The Linkage Engine 40 utilizes the corresponding stored Linkage Instructions 110 (which would specify, for example, that ‘Acme Corp.’, ‘ACME Corporation’, and ‘Acme Co.’ all map to the standardized value ‘Acme Corporation’). The combined action of these modules effectively transforms the inconsistent input values into their single, canonical representation defined in the Standardized List 100. The diagram shows the Standardization Module 30 and Linkage Engine 40 processing the incoming data streams.

The Reporting Module 60 then takes this harmonized, standardized data set. It aggregates, summarizes, or otherwise processes this consistent data according to the requirements of the desired output. For example, it could calculate total transactions associated with ‘Acme Corporation’ by summing contributions that originated from records containing ‘Acme Corp.’, ‘ACME Corporation’, or ‘Acme Co.’ across all three sources. The final result generated by the Reporting Module 60 is the Consolidated Data Output 120. This output presents a unified and accurate view (e.g., a single line item for ‘Acme Corporation’ in a report, a correctly aggregated bar in a chart) that reflects the true picture across all sources, something impossible to achieve reliably without the preceding normalization step driven by the Standardization Module 30 and Linkage Engine 40 based on the user's initial field selection from any source. The diagram shows the Reporting Module 60 receiving the processed data and producing the Consolidated Data Output 120.

Referring now to FIG. 9, this flowchart details the internal workflow of the AI-based linkage capability (AI-based linkage workflow 130), which is a sophisticated function executed within the Linkage Engine 40. This workflow leverages artificial intelligence to automate or assist in the process of associating Source Data Values (from the user-selected Target Data Field 150) with elements in the target Standardized List 100. The flowchart outlines the sequence of steps involved in this AI-driven process.

The workflow initiates when the Linkage Engine 40 receives the relevant inputs: the set of unique Source Data Values retrieved for the Target Data Field 150, and the corresponding Standardized List 100. These inputs are shown entering the “AI Linkage Techniques” step.

The core of the workflow involves applying AI Linkage Techniques. The Linkage Engine 40 employs one or more AI models or algorithms specifically designed for this type of matching task. These techniques could include: Natural Textual Processing (NLP) models for understanding semantic similarity between textual values (e.g., recognizing that ‘Chief Exec. Officer’ is equivalent to ‘CEO’), machine learning classification models trained on historical user linkage decisions or industry-specific data, clustering algorithms to group similar source values together before linkage, knowledge graph lookups, or other predictive analytic methods. Preferably, the historical user linkage decisions comprise prior confirmed linkages. These techniques analyze patterns, similarities, and potentially contextual information to determine the most likely linkage between each source value and an entry in the Standardized List 100. This step is represented as the application of “AI Linkage Techniques”.

Based on this analysis, the AI Linkage Techniques generate Proposed Linkage Instructions 110. These are tentative associations, often accompanied by a confidence score indicating the AI's certainty about the proposed match. The flowchart shows “Generate Proposed Linkage Instructions (110)” as the output of the AI techniques. Preferably, the confidence score indicating the AI's certainty about the proposed match is a significance measure indicating strength of the proposed association.

The workflow then typically includes an optional but often crucial User Evaluation step, facilitated through the User Interface Module 20. The system may present all proposed linkages, or only those below a certain confidence threshold, to the user. Preferably, the proposed linkages presented to the user are AI-proposed alternatives. The user interacts via Manual Input controls to evaluation the AI's suggestions. They can Accept a proposed linkage, Reject it (leaving the source value unmapped or manually linkage it elsewhere), or Modify the suggestion (e.g., confirming a slightly different standard value). This user feedback is critical for ensuring accuracy and can also be used (optionally) to retrain or fine-tune the AI models over time, improving future predictions. Preferably, modifying the suggestion or otherwise providing user feedback is refining the proposed linkages. The flowchart shows a decision point for “User Evaluation (via UI 20)” and a path for “Manual Input” feeding back. [046] If the User Evaluation step is bypassed (e.g., for high-confidence proposals or by user configuration), or after the user completes their evaluation and provides Manual Input, the linkages are finalized. Accepted or user-confirmed proposals become Confirmed Linkage Instructions 110. The flowchart shows paths leading to “Confirmed Linkage Instructions (110)”.

These Confirmed Linkage Instructions 110 are the definitive outcome of the AI-assisted linkage process for the processed batch of source values. They are then persistently stored in the Storage Module 50 for reliable, repeatable use. Furthermore, these finalized instructions are provided as Output for Reporting/Processing, meaning they are immediately available to the Reporting Module 60 for generating consolidated outputs or to the Data Synchronization Module 70 if source system updates are intended. This AI workflow significantly enhances the efficiency and scalability of linkage, particularly for large volumes of data corresponding to the user-selected Target Data Field 150 from any source, while maintaining accuracy through optional user oversight. The flowchart shows the Confirmed Linkage Instructions being stored and provided as output.

Referring now to FIG. 10, this flowchart details the Source System Update Process 140, an optional but powerful capability managed by the Data Synchronization Module 70. This process enables the system to propagate the results of the normalization back to the originating Heterogeneous Data Sources 90, thereby improving data quality at the source for the user-selected Target Data Field 150. The flowchart maps the sequence of steps involved in pushing updates back to source systems.

The process begins at Step A (Initiate Source System Update Process). A check is performed (Step B: Standardized Data Ready?) to ensure that the normalization and linkage for the relevant data (based on the Target Data Field 150) have been completed and are available for synchronization. If ready (‘Yes’ path), the Data Synchronization Module 70 proceeds to retrieve the necessary information from the Storage Module 50 (Step C: Retrieve Standardized Data and Linkage Context). This includes the relevant elements from the Standardized List 100 and the corresponding Linkage Instructions 110 that link original source values (or records) to their standardized counterparts. The flowchart shows retrieval from Storage Module (50).

With this information, the Data Synchronization Module 70 prepares the update instructions (Step D: Prepare Update Instructions). This involves translating the standardized values and linkage context into the specific format required by the API or data modification mechanism of each target source system. This step ensures compatibility with the diverse Heterogeneous Data Sources 90. The flowchart shows this preparation step.

Next, the module identifies the specific Heterogeneous Data Sources 90 that contain the data to be updated (Step E: Identify Target Source Systems). This might involve one or multiple source systems depending on where the data for the Target Data Field 150 originated. The flowchart shows this identification step.

The core action occurs at Step F: Transmit Update Instructions to Source Systems. The Data Synchronization Module 70 sends the prepared instructions to the identified sources, initiating the data modification (e.g., updating an account record's name field, changing a product code in an resource database). The flowchart shows the transmission step.

Following transmission, the system attempts to verify the outcome (Step G: Update Successful?). This might involve checking response codes from APIs or querying the source system. If the update is confirmed as successful (‘Yes’ path), the success event is logged, potentially within the Storage Module 50 (Step H: Log Confirmation), and this specific update cycle concludes (Step J: End Process). If the update fails or cannot be confirmed (‘No’ path), an error handling routine is triggered (Step I: Error Handling and Retry). The system checks if a predefined retry limit for this update attempt has been exceeded (Step K: Retry Limit Reached?). If the limit has not been reached (‘No’ path), the system may wait and then attempt to re-transmit the update instructions (loop back to Step F). If the retry limit has been reached (‘Yes’ path), the failure is definitively reported, perhaps generating an alert for an administrator (Step L: Report Update Failure), and the process for this failed update concludes (Step J). This structured process with error handling and retries provides a robust mechanism for pushing data consistency back to the source systems for the user-selected field. The flowchart clearly depicts the success and failure paths, including retries.

Referring now to FIG. 11, this block diagram illustrates the structure and user interface elements associated with the Predefined Standard List Library 80. This library is a component designed to accelerate the setup of normalization tasks by providing users with ready-made, reusable standardized lists for common data fields, accessible via the User Interface Module 20 and managed in conjunction with the Standardization Module 30. The diagram shows the organization of the library and the tools for interacting with it.

Access to the library is typically provided through the User Interface Module 20, often via a dedicated Standard List Selection Panel. This panel might visually organize the library's contents using elements like a Category Listing 210 (e.g., a tree view or list grouping lists by type or domain) and potentially a Domain Visualization 220 (e.g., icons or tags indicating significance to Finance, Healthcare, Sales, etc.). The panel also often provides access to manage user-specific Custom Lists 250 that might have been saved previously. These interface elements are depicted within the User Interface Module 20 section of the diagram.

The Predefined Standard List Library 80 itself is a repository stored likely within or managed via the Storage Module 50. It contains a collection of standardized lists curated for common business needs. FIG. 11 shows it organized into logical sections: Industry Lists 230: Contains lists tailored to specific vertical domains. Examples include: Accounting Standards 260: Standard chart of accounts templates (e.g., based on GAAP or IFRS principles), common expense categories, standard financial ratios definitions. Medical Device Classifications 270: FDA GUDID device types, clinical equipment categories, regulatory classifications. Product Categories 280: Product classifications, catalog categories, SKU groupings. General Lists 240: Contains lists applicable across many domains. Examples include: Name Standards 290: Rules or lists for standardizing personal names (e.g., prefixes, suffixes) or organization names (e.g., legal entity types like Inc., Ltd., LLC). Location Standards 300: Standard country lists (e.g., ISO 3166), state/province abbreviations, address component standards. These categories and examples are shown as components within the Predefined Standard List Library 80 block.

Interaction with the library is facilitated by the Standardization Module 30, which provides associated tools accessible via the User Interface Module 20: Import Tool 310: Allows administrators or users to add new standard lists to the library 80 from external files or sources. Export Function 320: Enables users to export lists from the library 80, perhaps for sharing or backup. Standardized List Manager 330: Provides the core functionality for browsing the library, searching for relevant lists, viewing list contents, selecting a list for use in a normalization task, and potentially customizing a library list before use (saving it as a Custom List 250). These tools are shown as components within the Standardization Module 30 block, interacting with the Predefined Standard List Library 80.

When a user, having selected a Target Data Field 150 (FIG. 4), navigates this interface and selects a suitable list from the Predefined Standard List Library 80 (e.g., selecting a Medical Device Classification list when the Target Data Field is ‘DeviceDescription’), that selected library list is loaded and becomes the active Standardized List 100 for the current normalization process (feeding into FIG. 5 and FIG. 6). This significantly streamlines the process compared to manually creating every standardized list from scratch, promoting best practices and consistency, especially when normalizing commonly encountered fields like account names, product codes, device specifications, or location identifiers across diverse Heterogeneous Data Sources 90. The diagram illustrates the flow from the library selection to the Standardized List 100.

One of ordinary skill in the art will appreciate that the AI-driven linkage techniques described herein, including vector embedding generation, similarity scoring, and confidence-threshold filtering, can be implemented using any suitable modern textual model or sequence-embedding model. Preferably, selecting among the similarity scores comprises selecting a highest similarity score. Non-limiting examples include open-weight sequence-transformer architectures (e.g., SBERT, MiniLM, E5), proprietary embedding APIs (e.g., text-embedding-3, Claude vector encodings), or custom fine-tuned models trained on domain-specific linkage corpora. Preferably, the suitable modern textual model is a large sequence-based model. The choice of embedding model does not limit the scope of the invention; any model capable of producing fixed-length vector encodings of textual data values that preserve semantic similarity is suitable. The confidence threshold T is configurable and may be set per field type, per industry, or per data source, with typical operational ranges between 0.70 and 0.98. Preferably, setting the confidence threshold T per field type comprises configuring the confidence threshold T on a per-data-field-type basis. Preferably, setting the confidence threshold T per data source comprises configuring the confidence threshold T on a per-data-source basis. The feedback loop whereby confirmed and corrected linkages update the embedding retain in transient memory or fine-tune the model operates as a standard reinforcement-from-human-feedback (RLHF) or supervised fine-tuning pipeline, well understood in the art as of the filing date. Preferably, setting the confidence threshold T per industry comprises configuring the confidence threshold T on a per-industry-vertical basis.

In another embodiment, the system normalizes medical device specifications from clinical maintenance management systems (CMMS) against a regulatory device database such as the FDA Global Unique Device Identification Database (GUDID), enabling standardized equipment identification across healthcare facilities. In this embodiment, the heterogeneous data sources comprise hospital resource systems containing unstructured device specifications, manufacturer names, and model numbers, and the standardized list comprises regulatory device identifiers. The AI model generates proposed linkages using the same embedding, similarity scoring, and confidence threshold techniques described herein, and confirmed linkages propagate as learned standards across multiple healthcare facilities connected to the system.

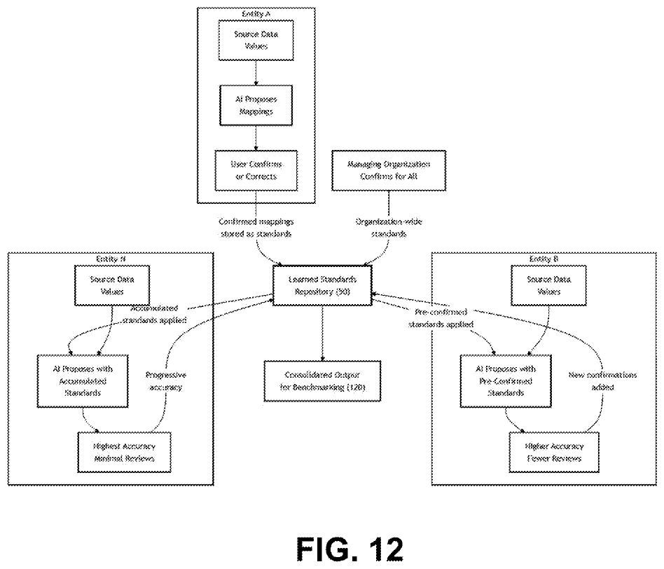

Referring now to FIG. 12, this flowchart illustrates the cross-entity learning and progressive accuracy process. When Entity A connects to the system and the AI Linkage Engine 40 proposes linkages for its source data values, a user at Entity A evaluations, confirms, or corrects the proposed linkages. These Confirmed Linkage Instructions 110 are stored in the Learned Standards Repository within the Storage Module 50 as learned standards. When Entity B subsequently connects, the system automatically applies Entity A's learned standards as pre-confirmed linkages, significantly reducing the number of items requiring manual evaluation at Entity B. Preferably, automatically applying Entity A's learned standards as pre-confirmed linkages is reusing a confirmed linkage as a pre-confirmed linkage for subsequent entities. Entity B's additional confirmations and corrections are added to the repository, further enriching the accumulated standards. This process repeats for each subsequent Entity N, with each new entity benefiting from all previously confirmed linkages, such that the accuracy of proposed linkages progressively increases as additional entities are processed. A Managing Organization overseeing a plurality of entities—such as a franchisor overseeing franchise locations, or a services company overseeing multiple hospital facilities—may confirm linkage standards that are automatically applied across all connected entities simultaneously, bypassing the entity-by-entity confirmation process. The accumulated learned standards feed into the Reporting Module 60 to produce Consolidated Data Output 120 for cross-entity comparing, consolidated reporting, and enterprise-wide analytics, enabling direct performance comparison across entities that previously used incompatible data encodings.

While a particular form of the invention has been illustrated and described, it will be apparent that various modifications can be made without departing from the spirit and scope of the invention. For example, the system could be extended to support automatic detection of fields across multiple data sources that would benefit from standardization based on pattern recognition or similarity analysis, proactively suggesting Target Data Fields 150 to the user. Accordingly, the invention is not intended to be limited except as by the appended claims.

Particular terminology used when describing certain features or aspects of the invention should not be taken to imply that the terminology is being redefined herein to be restricted to any specific characteristics, features, or aspects of the invention with which that terminology is associated. The terms used in the following claims should not be construed to limit the invention to the specific embodiments disclosed in the specification unless the above Detailed Description section explicitly defines such terms. Accordingly, the actual scope of the invention encompasses not only the disclosed embodiments but also all equivalent ways of practicing or implementing the invention.

The above-detailed description of the embodiments of the invention is not intended to be exhaustive or to limit the invention to the precise form disclosed above or to the particular field of usage mentioned in this disclosure. While specific embodiments of, and examples for, the invention are described above for illustrative purposes, various equivalent modifications are possible within the scope of the invention, as those skilled in the relevant art will recognize. Also, the teachings of the invention provided herein can be applied to other systems, not necessarily the system described above. The elements and acts of the various embodiments described above can be combined to provide further embodiments.

All of the above patents and applications and other references, including any that may be listed in accompanying filing papers, are incorporated herein by reference. If necessary, aspects of the invention can be modified to employ the systems, functions, and concepts of the various references described above to provide yet further embodiments of the invention.

Changes can be made to the invention in light of the above “Detailed Description.” While the above description details certain embodiments of the invention and describes the best mode contemplated, no matter how detailed the above appears in the text, the invention can be practiced in many ways. Therefore, implementation details may vary considerably while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated.

While certain aspects of the invention are presented below in certain claim forms, the inventor contemplates the various aspects of the invention in any number of claim forms. Accordingly, the inventor reserves the right to add additional claims after filing the application to pursue such additional claim forms for other aspects of the invention.

### Conclusion

For clarity of explanation, the above description has focused on a representative sample of all possible embodiments, a sample that teaches the principles of the invention and conveys the best mode contemplated for carrying it out. The invention is not limited to the described embodiments. Well known features may not have been described in detail to avoid unnecessarily obscuring the principles relevant to the claimed invention. Throughout this application and its associated file history, when the term “invention” is used, it refers to the entire collection of ideas and principles described; in contrast, the formal definition of the exclusive protected property right is set forth in the claims, which exclusively control. The description has not attempted to exhaustively enumerate all possible variations. Other undescribed variations or modifications may be possible. Where multiple alternative embodiments are described, in many cases it will be possible to combine elements of different embodiments, or to combine elements of the embodiments described here with other modifications or variations that are not expressly described. A list of items does not imply that any or all of the items are mutually exclusive, nor that any or all of the items are comprehensive of any category, unless expressly specified otherwise. In many cases, one feature or group of features may be used separately from the entire apparatus or methods described. Many of those undescribed alternatives, variations, modifications, and equivalents are within the literal scope of the following claims, and others are equivalent. The claims may be practiced without some or all of the specific details described in the specification. In many cases, method steps described in this specification can be performed in different orders than that presented in this specification, or in parallel rather than sequentially, or in different computers of a computer network, rather than all on a single computer. It is to be understood that the present technology contemplates that, to the extent possible, one or more features of any implementation can be combined with one or more features of any other implementation.

While the above description details certain embodiments of the invention and describes the best mode contemplated, no matter how detailed the above appears in text, the invention can be practiced in many ways. Therefore, implementation details may vary considerably while still being encompassed by the invention disclosed herein. Particular terminology used when describing certain features or aspects of the invention should not be taken to imply that the terminology is being redefined herein to be restricted to any specific characteristics, features, or aspects of the invention with which that terminology is associated.

Any specific manifestations of these and other similar example processes are not intended to be limiting to the disclosure. Any suitable manifestation of these and other similar example processes can be selected within the scope of the illustrative embodiments.

Thus, a computer-implemented method, system or apparatus, and computer program product are provided in the illustrative embodiments for systems and methods for ai-driven dynamic data normalization for heterogeneous data sources and other related features, functions, or operations. Where an embodiment or a portion thereof is described with respect to a type of device, the computer-implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser, or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

The present disclosure may be a system, a method, and/or a computer program product at any possible technical detail level of integration. The computer program product may include a computer-readable storage medium (or media) having computer-readable program instructions thereon for causing a processor to carry out aspects of the present disclosure.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming textuals, including an object oriented programming textual such as Smalltalk, C++, or the like, and procedural programming textuals, such as the “C” programming textual or similar programming textuals. The computer-readable program instructions may execute entirely on a dedicated system or user's computer, partly on the user's computer or dedicated system as a stand-alone software package, partly on the user's computer and partly on a remote computer or entirely on the remote computer or server, etc. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer-readable program instructions by utilizing state information of the computer-readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other device to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

All features disclosed in the specification, including the claims, abstract, and drawings, and all the steps in any method or process disclosed, may be combined in any combination, except combinations where at least some of such features and/or steps are mutually exclusive. Each feature disclosed in the specification, including the claims, abstract, and drawings, can be replaced by alternative features serving the same, equivalent, or similar purpose, unless expressly stated otherwise.

What is claimed is:

1. A computer-implemented method for normalizing data across a plurality of heterogeneous data sources, comprising:
a. establishing electronic connections to the plurality of heterogeneous data sources, each comprising a plurality of data fields;
b. receiving, from a user, a selection of a target data field from at least one source, representing a data element to be normalized;
c. generating or selecting a standardized list associated with the target data field, comprising predefined standard values;
d. retrieving data values corresponding to the target data field from the sources;
e. generating, via an artificial intelligence model, proposed linkages between one or more of the retrieved data values and elements in the standardized list, each proposed linkage having an associated significance measure indicating strength of the proposed association;
f. presenting the proposed linkages and associated significance measures to a user for evaluation, wherein the user may confirm, reject, correct, or provide feedback to refine the proposed linkages;
g. storing or retaining in transient memory linkages as linkage instructions;
h. generating a consolidated data output, transforming data values to conform to the standardized list for comparing, consolidated reporting, and cross-entity analysis.

2. The method of claim 1, wherein an AI model generates proposed linkages by producing vector encodings for each retrieved data value and each standard value, computing similarity scores between vector encodings, and selecting the standard value with a highest similarity score for each data value when that score exceeds a configurable confidence threshold T.

3. The method of claim 2, wherein the vector encodings are generated using a sequence-transformer model, a large sequence-based model, or a domain-specific representation model fine-tuned on prior confirmed linkages.

4. The method of claim 2, wherein the confidence threshold T is configurable per data field type, per industry vertical, or per data source.

5. The method of claim 1, wherein confirmed linkage instructions are stored as learned standards that are automatically applied to at least a same entity or one or more other entities connected to a system, such that a linkage confirmed by an entity or by a managing organization overseeing a plurality of entities is reused as a pre-confirmed linkage for subsequent entities, and wherein an AI model is progressively updated based on accumulated confirmed linkages and user feedback across all connected entities, such that accuracy of proposed linkages increases as additional entities are processed.

6. The method of claim 1, wherein generating or selecting the standardized list comprises receiving an industry type selection and configuring with the standardized list with predefined elements based on the industry type.

7. The method of claim 1, wherein the target data field comprises at least one of: chart-of-accounts elements, entity identifiers, product and service codes, event records, medical device specifications, or location identifiers.

8. The method of claim 1, wherein the heterogeneous data sources comprise at least two of: accounting systems, resource management systems, clinical maintenance management systems, client relationship management systems, resource management systems, or point-of-capture systems.

9. The method of claim 1, wherein generating proposed linkages further comprises applying similarity criteria including exact string matching, fuzzy text matching, or pattern recognition prior to or in combination with an AI model.

10. The method of claim 1, further comprising transmitting correction instructions to at least one data source to update data values at the source to align with the standardized list.

11. The method of claim 1, wherein generating the standardized list comprises: a. identifying unique data values for the target data field across the sources; b. presenting the unique values to the user; c. receiving user selections to include values in the standardized list or associate values with existing standard elements.

12. The method of claim 1, wherein the user evaluation is conducted without a manual field-to-field linkage interface, and wherein user feedback comprises natural sequence-based input provided through a interactive AI assistant, selection from AI-proposed alternatives, or rule-based pattern constraints.

13. The method of claim 1, wherein feedback provided for one data value is automatically propagated to similar data values across one or more entities connected to a system having comparable characteristics.

14. A system for normalizing data across a plurality of heterogeneous data sources, comprising:
a. a data connection module configured to establish connections to the data sources;
b. an AI linkage engine configured to generate proposed linkages between one or more retrieved data values and elements in a standardized list, each proposed linkage having an associated significance measure;
c. a user interface module configured to present proposed linkages and significance measures for user evaluation, wherein the user may confirm, reject, correct, or provide feedback to refine the proposed linkages;
d. a standardization module configured to generate or select a standardized list with predefined values;
e. a storage module configured to store confirmed linkage instructions and AI model state;
f. a reporting module configured to generate consolidated outputs transforming data to conform to the standardized list.

15. The system of claim 14, wherein the AI linkage engine is configured to generate the proposed linkages by producing vector encodings for each retrieved data value and each standard value, computing similarity scores between the vector encodings, and selecting, for each data value, the standard value having a highest similarity score when the highest similarity score exceeds a configurable confidence threshold T.

16. The system of claim 15, wherein the vector encodings are generated using a sequence-transformer model, a large sequence-based model, or a domain-specific embedding model fine-tuned on prior confirmed linkages.

17. The system of claim 15, wherein the confidence threshold T is configurable on a per-data-field-type basis, a per-industry-vertical basis, or a per-data-source basis.

18. The system of claim 14, wherein the storage module is configured to store the confirmed linkage instructions as learned standards that are automatically applied to at least a same entity or one or more other entities connected to the system, such that a linkage confirmed by an entity or by a managing organization overseeing a plurality of entities is reused as a pre-confirmed linkage for subsequent entities, and wherein the AI linkage engine is progressively updated based on accumulated confirmed linkages and user feedback across the connected entities such that accuracy of subsequently generated proposed linkages increases as additional entities are processed.

19. A non-transitory computer-readable medium storing instructions that, when executed by a processor, cause a system to:
a. establish connections to a plurality of heterogeneous data sources;
b. receive a user-selected target data field;
c. generate or select a standardized list;
d. retrieve data values for the target field from the data sources;
e. generate, via an artificial intelligence model, proposed linkages between one or more of the retrieved data values and elements in the standardized list, each having an associated significance measure;
f. present proposed linkages and significance measures for user evaluation, wherein the user may confirm, reject, correct, or provide feedback;
g. store or retain in transient memory confirmed linkage instructions;
h. generate a consolidated output using standardized values.

20. The non-transitory computer-readable medium of claim 19, wherein generating or selecting the standardized list comprises receiving an industry type selection and configuring with the standardized list with predefined elements based on the industry type.
